(19) United States
(12) Patent Application Publication
(10) Pub. No.: US 2007/0019427 A1
(43) Pub. Date: Jan. 25, 2007

(54) System and apparatus for automotive illumination

(76) Inventor: Richard G. Brandl, Hudson, FL (US)

Correspondence Address: LARSON AND LARSON, 11199 69TH STREET NORTH, LARGO, FL, 33773, US

(21) Appl. No.: 11/187,335

(22) Filed: Jul. 22, 2005

(51) Int. Cl. B60Q 1/26

(52) U.S. Cl. 362/500

(57) ABSTRACT

A system for illuminating an automobile, projecting visible light through the wheel of the vehicle. An annular light source is coupled to a source of electricity and is mounted outside the vehicle braking system and within the vehicle wheel using L-brackets affixed to the annular light source and affixed to a stationary portion of the automobile drive system.

### BACKGROUND OF THE INVENTION

1. Field of the Invention

This invention relates to the field of automotive illumination systems and more particularly to a system for illuminating a wheel of an automobile.

2. Description of the Related Art

There are many ways to illuminate an automobile. Some ways are functional, while some ways are more decorative. For example, headlights are more functional than decorative because they allow the driver to see where they are going at night. Another example is lighted license plate holders that provide a more decorative look. Some lighting systems are both decorative and functional. For example, a string of lights along the side panel of an automobile may look good to some people and may make the vehicle more visible during low lighting conditions, possibly avoiding accidents.

Wheel illumination systems are known in the prior art, including U.S. Pat. No. 6,176,603 to Spicer, which is hereby incorporated by reference. While the prior art fulfills its objectives by providing illumination to automotive wheels, it lacks structural integrity, ease of installation, universal installation and placement of the lighting within the wheel area.

What is needed is a system for illuminating the inside area of automotive wheels that is sturdy while positioning the illuminating surface at an optimal location.

### SUMMARY OF THE INVENTION

In one embodiment, a system for illuminating an automobile is disclosed including an annular light source with a light and a protective rim. A plurality of L-shaped metal brackets attach annular light source to the automotive drive system.

In another embodiment, a system for illuminating an automobile is disclosed including an annular light source with a light connected to a source of electricity and a protective rim and affixed at the protective rim to a first end of a plurality of L-brackets. The second end of the plurality of L-shaped metal brackets is affixed to an automotive drive system, the automotive drive system utilizing disc brakes.

In another embodiment, a system for illuminating an automobile is disclosed including an annular light source with a light connected to a source of electricity and a protective rim and affixed at the protective rim to a first end of a plurality of L-brackets. The second end of the plurality of L-shaped metal brackets is affixed to an automotive drive system, the automotive drive system utilizing drum brakes.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates an exploded view of a system of a first embodiment of the present invention.

FIG. 2 illustrates an assembled view of the first embodiment of the present invention.

FIG. 3 illustrates an exploded view of a system of a second embodiment of the present invention.

FIG. 4 illustrates an assembled view of the second embodiment of the present invention.

FIG. 5 illustrates a sectional view of an annular light assembly of both embodiments of the present invention.

FIG. 6 illustrates an outside view of an annular light assembly of both embodiments of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

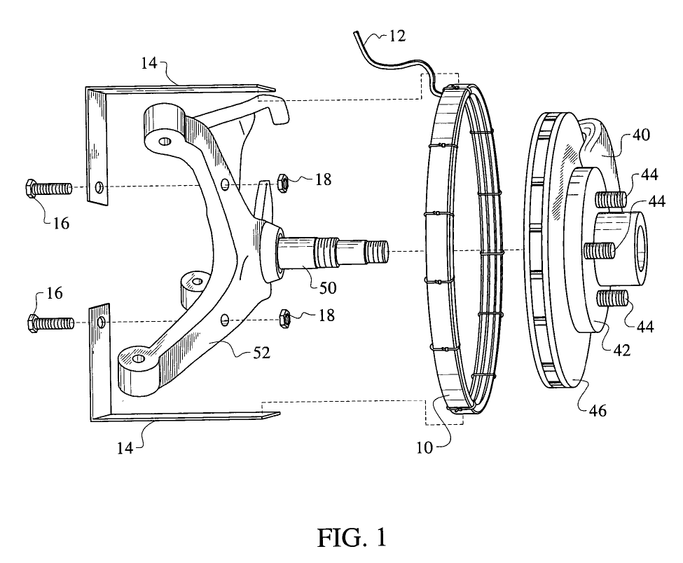

Referring to FIG. 1, an exploded view of a system of a first embodiment of the present invention is shown. This embodiment is best suited for wheels with disc brake systems. The annular wheel light 10 is attached to the stationary spindle 52 of an automobile by a plurality of L-brackets 14 affixed at a first end to existing holes in the spindle 52 with fasteners, in this example bolts 16 and nuts 18, although various fasteners work equally as well and some include washers or lock washers. The L-bracket is affixed at a second end to the annular wheel light 10 by adhesive, glue, weld or any other way known in the art. The annular wheel light 10 is electrically connected to the vehicle power system by electrical cables 12.

For completeness, the rest of the automotive wheel attachment and braking system is shown including a brake caliper 40, a brake disc 46, a stub axle 50, a hub 42 and a number of lug bolts 44 for attaching a wheel (not shown).

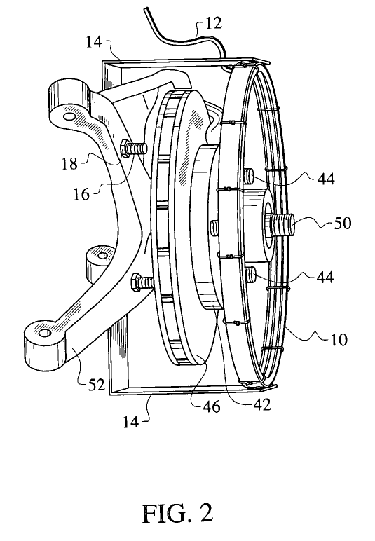

Referring to FIG. 2 an assembled view of the first embodiment of the present invention is shown. As in FIG. 1, the annular wheel light 10 is attached to the stationary spindle 52 of an automobile by a plurality of L-brackets 14 affixed at a first end to existing holes in the spindle 52 with fasteners, in this example bolts 16 and nuts 18, although various fasteners work equally as well and some include washers or lock washers. The L-bracket is affixed at a second end to the annular wheel light 10 by adhesive, glue, weld or any other way known in the art. The annular wheel light 10 is electrically connected to the vehicle power system by electrical cables 12.

For completeness, the rest of the automotive wheel attachment and breaking system is visible including a stub axle 50, a brake disc 46, a hub 42 and a number of lug bolts 44 for attaching a wheel (not shown).

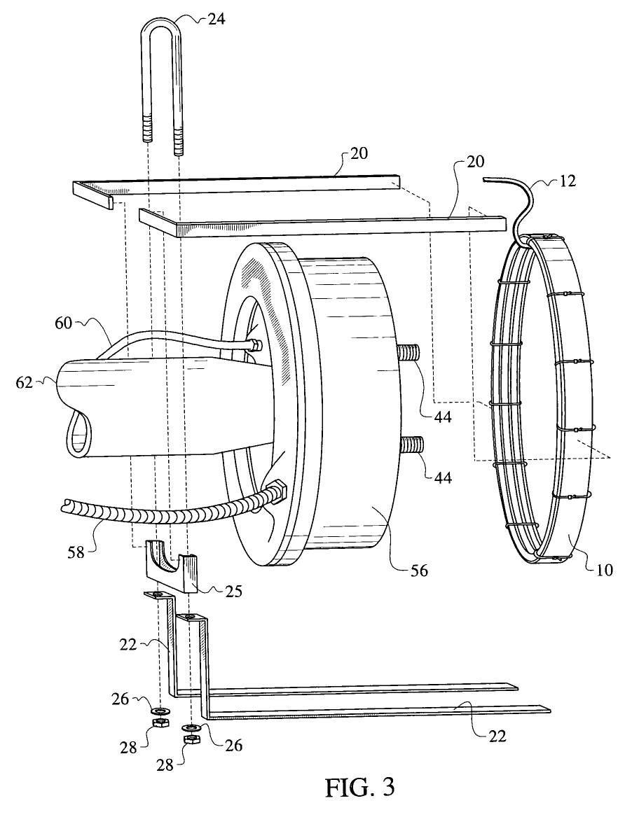

Referring to FIG. 3 an exploded view of a system of a second embodiment of the present invention is shown. This embodiment is best suited for wheels with drum brake systems. The annular wheel light 10 is attached to the axle housing 62 of an automobile by a plurality of L-brackets 20/22 affixed to the axle housing 62 with a U-shaped clamp. The annular wheel light 10 is electrically connected to the vehicle power system by electrical cables 12. The U-shaped clamp has a U-bolt 24 and a bracket 25 held in place by two nuts 28. In some embodiments a washer or lock washer 26 is placed over the threaded end of the U-bolt 24 between the nuts 28 and the bracket 25.

For completeness, the rest of the automotive wheel attachment and breaking system is shown including a brake drum 56, a brake hydraulic line 60, an emergency brake cable 58 and a number of lug bolts 44 for attaching a wheel (not shown).

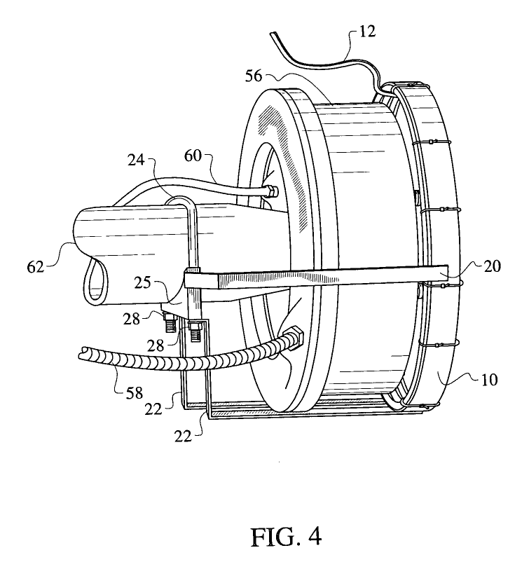

Referring to FIG. 4 an assembled view of the second embodiment of the present invention is shown. The annular wheel light 10 is attached to the axle housing 62 of an automobile by a plurality of L-brackets 20/22 affixed to the axle housing 62 with a U-shaped clamp having a U-bolt 24 and a bracket 25 held in place by two nuts 28. A first end of a first set of L-brackets 22 are affixed to the annular wheel light 10 light by adhesive, glue, weld or any other way known in the art. The second end of the first set of L-brackets has holes through which the ends of the U-bolt pass and are held against the U-bolt bracket 25 by nuts 28. Although not visible in FIG. 4, in some embodiments, washers or lock washers are also used. A second set of L-brackets 20 are affixed at a first end to the annular wheel light 10 light by adhesive, glue, weld or any other way known in the art. The second end of the second set of L-brackets are affixed to U-bolt bracket 25 by adhesive, glue, weld or any other way known in the art. In some embodiments, the second set of L-brackets are bent at the U-bolt end and pass under the U-bolt 24, between the U-bolt 24 and the axle housing 62 and are held in place when the U-bolt 24 and U-bolt bracket are tightened using nuts 28.

The annular wheel light is electrically connected to the vehicle power system by electrical cables 12.

For completeness, the rest of the automotive wheel attachment and breaking system is shown including a brake drum 56, a brake hydraulic line 60 and an emergency brake cable 58.

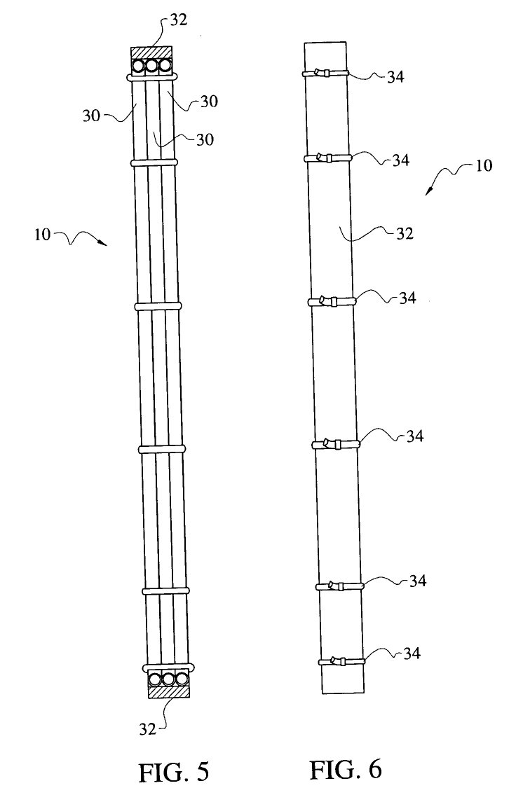

Referring to FIG. 5 a sectional view from the inside of an annular wheel light 10 of both embodiments of the present invention is shown. A protective rim 32 provides structural support and protection for one or more light tubes 30 (three are shown in this example). The protective rim is made of a sturdy, stiff material such as steel, iron, copper and nylon. In this embodiment, the light tubes 30 are neon light tubes. In other embodiments, the light tubes 30 are formed of a clear or translucent material containing a plurality of individual lights or light emitting diodes (LEDs), connected in series, parallel or series/parallel. In other embodiments, the light tubes 30 are translucent light pipes and a light source such as LEDs illuminate one or both ends of the light pipe, sending light down the light pipe and scattering the light somewhat equally along the length of the light pipe.

Referring to FIG. 6 an outside view of an annular wheel light 10 of both embodiments of the present invention is shown. Visible is the protective rim 32. In some embodiments, the light tubes 30 are held against the protective rim 32 by a plurality of wire ties 34, although in some embodiments, the light tubes 30 are affixed to the protective rim by adhesive or glue.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An automotive lighting system, the system comprising:
an annular light source comprising a light means and a protective rim, the light means connected to a source of electricity;
a plurality of L-shaped metal brackets affixed at a first end to the protective rim; and
a means for fastening a second end of the plurality of L-shaped metal brackets to an automotive drive system.

2. The automotive lighting system of claim 1, wherein the first end of the plurality of L-shaped metal brackets is affixed to the protective rim by an adhesive.

3. The automotive lighting system of claim 1, wherein the first end of the plurality of L-shaped metal brackets is affixed to the protective rim by a weld.

4. The automotive lighting system of claim 1, wherein the means for fastening includes a plurality of bolts, each of the plurality of bolts passing through a hole in the second end of one of the plurality of L-shaped metal brackets and passing through an existing hole in a spindle of the automotive drive system and held in place with a nut.

5. The automotive lighting system of claim 1, wherein means for fastening includes a U-shaped clamp, the U-shape clamp comprising a bracket and a U-shaped bolt sized to fit around an automotive axle housing, the second end of a first two of the plurality of L-shaped brackets affixed to the bracket of the U-shaped clamp and a second end of a second two of the L-shaped brackets having holes for mounting on the U-shaped bolt, held in place by nuts on a threaded end of the U-shaped bolt.

6. The automotive lighting system of claim 5, wherein the second end of the first two of the plurality of L-shaped metal brackets are affixed to the bracket of the U-shaped clamp by an adhesive.

7. The automotive lighting system of claim 5, wherein the second end of the first two of the plurality of L-shaped metal brackets are affixed to the bracket of the U-shaped clamp by a weld.

8. The automotive lighting system of claim 1, wherein the light means is a neon light tube.

9. The automotive lighting system of claim 1, wherein the light means is a plurality of light emitting diodes, the light emitting diodes mounted within a tube and connected to each other.

10. An automotive lighting system, the system comprising:
an annular light source comprising a light means and a protective rim, the light means connected to a source of electricity;
a plurality of L-shaped metal brackets affixed at a first end to the protective rim; and
a means for fastening a second end of the plurality of L-shaped metal brackets to an automotive drive system, the automotive drive system utilizing disc brakes.

11. The automotive lighting system of claim 10, wherein the plurality of L-shaped metal brackets are affixed at the first end to the protective rim by an adhesive.

12. The automotive lighting system of claim 10, wherein the plurality of L-shaped metal brackets are affixed at the first end to the protective rim by a weld.

13. The automotive lighting system of claim 10, wherein means for fastening includes a plurality of bolts, each of the plurality of bolts passing through a hole in the second end of one of the plurality of L-shaped metal brackets and passing through an existing hole in a spindle of the automotive drive system and held in place with a nut.

14. An automotive lighting system, the system comprising:
an annular light source comprising a light means and a protective rim, the light means connected to a source of electricity;
a plurality of L-shaped metal brackets affixed at a first end to the protective rim; and
a means for fastening a second end of the plurality of L-shaped metal brackets to an automotive drive system, the automotive drive system utilizing drum brakes.

15. The automotive lighting system of claim 14, wherein the plurality of L-shaped metal brackets are affixed at the first end to the protective rim by an adhesive.

16. The automotive lighting system of claim 14, wherein the plurality of L-shaped metal brackets are affixed at the first end to the protective rim by a weld.

17. The automotive lighting system of claim 14, wherein means for fastening includes a U-shaped clamp; the U-shape clamp comprising a bracket, a U-shaped bolt sized to fit around an automotive axle housing and two nuts; a first two of the plurality of L-shaped brackets affixed to the bracket of the U-shaped clamp and a second two of the plurality of L-shaped brackets having holes for mounting on the U-shaped bolt, held in place by the two nuts on a threaded end of the U-shaped bolt.

18. The automotive lighting system of claim 17, wherein the first two of the plurality of L-shaped metal brackets are affixed to the bracket of the U-shaped clamp by an adhesive.

19. The automotive lighting system of claim 17, wherein the first two of the plurality of L-shaped metal brackets are affixed to the bracket of the U-shaped clamp by a weld.

20. The automotive lighting system of claim 19, wherein the plurality of L-brackets is made from steel and the protective rim is made from steel.
